(19) United States
(12) Patent Application Publication
(10) Pub. No.: US 2010/0022706 A1
(43) Pub. Date: Jan. 28, 2010

(54) POLYURETHANES FILLED WITH CARBON BLACK AND WITH A HIGH DIELECTRIC CONSTANT BREAKDOWN STRENGTH

(75) Inventors: Werner Jenninger, Koeln (DE); Burkhard Köhler, Zierenberg (DE); Joachim Wagner, Koein (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/569,533

(22) Filed: Sep. 29, 2009

Related U.S. Application Data
(62) Division of application No. 12/012,574, filed on Feb. 4, 2008.

(30) Foreign Application Priority Data
Feb. 7, 2007 (DE) 10 2007 005 960.6

(51) Int. Cl. C08L 75/04

(52) U.S. Cl. 524/590

(57) ABSTRACT

The invention provides polyurethanes filled with carbon black, which are characterised by a high dielectric constant and high breakdown strength, and which are synthesised from polyalkylene oxides that have been produced by DMC catalysis. The compositions comprise polyether polyurethanes which are the reaction products of one or more polyisocyanates and one or more polyol components, the polyol components being comprised of a) polyalkylene oxides produced by DMC catalysis, and b) 0-50 wt. % of polyols free from catalyst residues, and B) 0.1-30 wt. % of carbon black.

### CROSS-REFERENCE TO RELATED APPLICATION

This application claims priority under 35 U.S.C.§119 (a-d) to German Application Serial No. 10 2007 005 960.6, filed Feb. 7, 2007.

### FIELD OF THE INVENTION

The present invention relates to soft polyurethanes filled with carbon black, which are characterised by a high dielectric constant and breakdown strength, and which are synthesised from polyalkylene oxides.

### BACKGROUND OF THE INVENTION

Electrically conducting polyurethanes filled with carbon black with a high modulus are described by Novak in European Polymer Journal (2004) 40 (7), 1417-1422. Electrically conducting compounds are however excluded for use as dielectric materials.

Compounds produced from carbon black and aqueous polyurethane dispersions are described in various literature references: Material Letters (2004) 58 (27-28), 3606-3609; Chinese Chemical Letters (2004) 15 (8), 1001-1004; Sensors and Actuators, B: Chemical (2005) B105 (2), 187-193.

The known polyurethane mixtures already exhibit a percolation effect with a low carbon black content of 0.7%, in which the conductivity over a wide range up to 10% and more of carbon black rises, and is greatly influenced by the action of gases and solvent vapours. This behaviour means that they are suitable for use as gas sensors, but are less suitable as dielectric materials.

Altafim describes in Materials Research (2003) 6 (2), 187-191 polyurethanes filled with carbon black, which contain castor oil as polyol component. Such compounds have however too high a modulus, since the OH equivalent weight of castor oil is 350 g/equiv.

US 2006096694-A describes non-conducting bonding agents with a high dielectric constant but a high modulus, which is caused by contained polyester polyols. Compounds with a low modulus are however desirable for some particular applications.

It was desirable, therefore, to provide polyurethane compounds with a high dielectric constant and high electrical breakdown strength, which are useful for example as dielectric materials in capacitors.

### SUMMARY OF THE INVENTION

It was found that polyurethanes filled with carbon black, wherein the polyurethanes contain as structural unit polyethers produced by DMC (Double Metal Cyanide) catalysis, are characterised by a high dielectric constant and electric breakdown strength. Comparable polyurethanes prepared from polyalkylene oxides produced by alkali metal hydroxide catalysis or which contain poly-THF, do not achieve the breakdown strength of the new compounds for a given dielectric constant.

The present invention provides polyurethane compositions filled with carbon black, the compositions comprising:
A) 99.9-70 wt. % of polyether polyurethanes which are the reaction products of one or more polyisocyanates and one or more polyol components, the polyol components being comprised of
   a) 50-100 wt. % of polyalkylene oxides, preferably propylene oxides, produced by DMC catalysis, and
   b) 0-50 wt. % of polyols free from catalyst residues, in particular those polyols that have been purified by distillation or by recrystallisation, or that have not been produced by ring-opening polymerisation of oxygen-containing heterocyclics,
   and
B) 0.1-30 wt. % of carbon black.

### DETAILED DESCRIPTION OF THE INVENTION

As used herein in the specification and claims, including as used in the examples

and unless otherwise expressly specified, all numbers may be read as if prefaced by the word “about”, even if the term does not expressly appear. Also, any numerical range recited herein is intended to include all sub-ranges subsumed therein.

Examples of the polyol components a) used in the new polyurethanes are the polyols described in WO 97/29146, EP-A 700 949 and EP-A-761 708. These are polyalkylene oxides that can be obtained by ring-opening polymerisation of epoxides, in which 85-100%, preferably 100% of propylene oxide is employed and the remainder can consist of butylene oxide, hexene oxide, vinyl oxirane, allyl glycidyl ether, butyl glycidyl ether, ethylhexyl glycidyl ether, epichlorohydrin, ethylene oxide, phenyl glycidyl ether or cresylglycidyl ether. Double metal cyanide (DMC) complexes, for example zinc hexacyanocobaltate, are used as catalyst. The advantageous use of such polyalkylene oxides in polyurethanes has already been described in U.S. Pat. No. 6,825,376 and US 2004067315, in which the higher selectivity of such polyols in the reaction with isocyanate for the desired application was striking.

The molecular weight (number average molecular weight Mn) of the polyol components a) incorporated in the polyurethane mixtures used according to the invention is preferably 1000-14000 g/mole, particularly preferably 1500-8500 g/mole. The functionality is preferably 2-6, particularly preferably 2.

As polyol component b) there are preferably used ethylene glycol, diethylene glycol, triethylene glycol, tertraethylene glycol, propylene glycol, dipropylene glycol, tripropylene glycol, tetrapropylene glycol, TMP, neopentyl glycol, pentaerythritol, cyclohexanedimethanol, butylenes glycol, castor oil, dehydrated castor oil, hydrogenated castor oil, dimmer diol, hexanediol, decanediol, dodecanediol, hydroxyfunctional oligobutadiene, hydrogenated hydroxyfunctional oligobutadiene, glycerol or TMP monoallyl ether.

The polyurethanes A) are preferably produced by reacting the polyol components a) and optionally b) with 1.0-1.1 equivalents of polyisocyanates at a temperature of 15°-120° C., preferably 18°-80° C., in the presence or absence of catalyst for the NCO—OH reaction, such as tin compounds or amines. The mixing of the components a), optionally b), polyisocyanate and B) is carried out in suitable mixing devices which can impart a high shear energy, such as for example in a Speedmixer, and if necessary by the additional action of ultrasound.

As polyisocyanates there are preferably used those from the following list: HDI, trimethyl-HDI, IPDI, dodecahydro-Ml, norbornane diisocyanate, bisisocyanatomethylcyclohexane, bisisocyanatomethylbenzene, TMXDI, 2,4-TDI or 2,6-TDI or their mixtures, 2,2-MDI, 2,4-MDI or 4,4-MDI or their mixtures, 3-nuclear-containing or oligo-MDI-containing MDI types, in which aliphatic isocyanates are preferred, the carbodiimides or dimers or trimers of the aforementioned diisocyanates containing 4-ring or 6-ring heterocycles, their adducts with low molecular weight polyols such as TMP, diethylene glycol or dipropylene glycol, and their urethane or allophanate prepolymers of polyols, which correspond to the aforedescribed component a). Particularly preferred are allophanate prepolymers such as are described in US 2005222365, which in a preferred embodiment are prepared from polyalkylene oxides which correspond to the component a) described above. In particular an allophanate prepolymer of a polypropylene oxide produced by DMC catalysis of molecular weight in the region of Mn=2000 and HDI, in which the allophanate reaction is preferably catalysed with zinc octoate, can preferably be used, and corresponds to the idealised formula I:

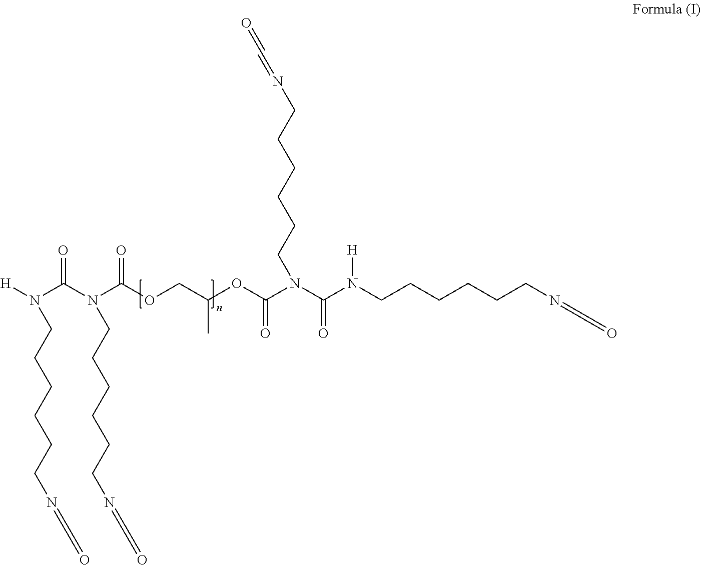

where n is a number from 30 to 38.

Carbon blacks of the component B) are in particular finely dispersed forms of carbon black, such as can be obtained commercially for example from Degussa AG. Forms of carbon black with a mean particle size of at most 1 μm, preferably at most 100 nm and particularly preferably at most 50 nm, are normally used. The carbon blacks should preferably at the same time have a large BET surface, the BET surface being greater than in particular 250 m²/g, preferably greater than 500 m²/g and particularly preferably greater than 900 m²/g.

The carbon black-filled polyurethanes according to the invention can be used as dielectric materials in equipment for converting mechanical into electrical energy and electrical energy into mechanical energy. Such energy converters are described for example in U.S. Pat. No. 6,343,129.

### EXAMPLES

The invention is further illustrated by the following non-limiting examples.

### Example 1

### Comparison Example

All liquid raw materials were carefully degassed in a three-stage process under argon, and the carbon black was screened through a 125 μm screen. 10 g of terathane 650 (INVISTA GmbH, D-65795 Hatterheim, poly-THF of molecular weight Mn=650) are weighed out together with 0.596 g of carbon black (Ketjenblack EC 300 J, produced by Akzo Nobel AG) in a 60 ml disposable mixing vessel (APM-Technika AG, Order No. 1033152) and were mixed in a Speedmixer (from APM-Technika AG, CH-9435 Heerbrugg; sales/marketing D: identification plate; type DAC 150 FVZ) for 3 minutes at 3000 rpm to form a homogeneous paste. 0.005 g of dibutyltin dilaurate (Metacure® T-12, Air Products and Chemicals, Inc.) and 6.06 g of the isocyanate N3300 (product from BayermaterialScience AG) are then weighed out into the paste and mixed for 1 minute at 3000 rpm in the Speedmixer. The reaction paste is poured onto a glass plate and spread with a doctor knife in a wet layer thickness of 500 μm to form a homogeneous film with a solids content of 2%. The film is then heated for 16 hours at 80° C.

The properties of the heat-treated film are given in the following Table 1.

### Example 2

### According to the Invention

All liquid raw materials were carefully degassed in a three-stage process under argon, and the carbon black was screened through a 125 μm screen. 10 g of Arcol PPG 2000 (product from BMS AG, DMC-catalysed polypropylene oxide of mean molecular weight Mn=2000) are weighed out together with 0.636 g of carbon black (Ketjenblack EC 300 type) in a 60 ml disposable mixing vessel and are mixed for three minutes at 3000 rpm in a Speedmixer. 0.005 g of dibutyltin dilaurate and 7.13 g of the isocyanate Desmodur XP 2599 (product from Bayer MaterialScience AG, allophanate prepolymer of the formula I, in which Arcol PPG 2000 was used as polyalkylene oxide) are then weighed out into the paste and mixed for 1 minute at 3000 rpm in the Speedmixer. The reaction paste is poured out onto a glass plate and spread with a doctor knife in a wet layer thickness of 500 μm to form a homogeneous film with a solids content of 2%. The film is then heated for 16 hours at 80° C.

The properties of the heat-treated film are given in the following Table 1.

TABLE 1
Measurement data

| | | | DC volume | Breakdown field |
|---|---|---|---|---|
| | Solids | DC dielectric | conductivity | strength |
| Example | content % | constant | S/cm | MV/m |
| 1 | 2 | <4 | 5E−6 | 5 |
| 2 | 2 | 700 | 6E−11 | 30 |

The advantage of the polyurethane composition according to the invention is demonstrated in the significantly higher dielectric constant and a significantly lower volume conductivity combined with a significantly higher breakdown field strength.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Polyurethane compositions filled with carbon black, the compositions comprising:
A) 99.9-70 wt. % of polyether polyurethanes which are the reaction products of one or more polyisocyanates and one or more polyol components, the polyol components being comprised of
a) 50-100 wt. % of polyalkylene oxides produced by DMC catalysis, and
b) 0-50 wt. % of polyols free from catalyst residues,
and
B) 0.1-30 wt. % of carbon black.

2. Polyurethane compositions according to claim 1, wherein the polyol component a) is 100 wt. %.

3. Polyurethane compositions according to claim 1, wherein allophanate prepolymers are used as isocyanates.

4. Polyurethane compositions according to claim 1, wherein the polyisocyanates are allophanate prepolymers prepared from polyalkylene oxides produced by DMC catalysis.

5. Polyurethane compositions according to claim 1, wherein the polyisocyanate is an allophanate prepolymer according to formula (I) 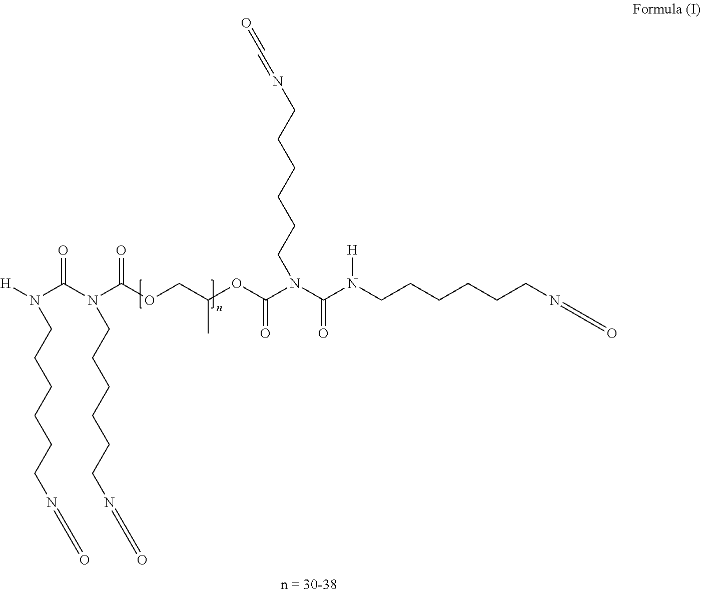
and the polypropylene oxide on which the prepolymer is based is produced by DMC catalysis.

6. The polyurethane compositions of claim 1, wherein the polyalkylene oxides of component a) are propylene oxides.

7. The polyurethane compositions of claim 1, wherein the polyols of component b) have been purified by distillation or by recrystallisation, or have not been produced by ring-opening polymerisation of oxygen-containing heterocyclics.

8. Dielectric materials in energy converters for converting mechanical energy into electrical energy and electrical energy into mechanical energy, said dielectric materials comprising the polyurethane compositions of claim 1.

9. Films or coatings, containing polyurethane compositions according to claim 1.

10. An energy converter containing polyurethane compositions according to claim 1 as dielectric material.

11. An electrical capacitor containing a polyurethane composition according to claim 1 as dielectric material.
